(19) United States
(12) Patent Application Publication
(10) Pub. No.: US 2003/0190001 A1
(43) Pub. Date: Oct. 9, 2003

(54) Clock and data recovery circuit for return-to-zero data

(75) Inventors: Roubik Gregorian, Saratoga, CA (US); Mir Bahram Ghaderi, Cupertino, CA (US); James Ban Ho, San Jose, CA (US); Vincent Sing Tso, Milpitas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Exar Corporation, Fremont, CA (US)

(21) Appl. No.: 10/118,661

(22) Filed: Apr. 8, 2002

(51) Int. Cl. H04L 7/02

(52) U.S. Cl. 375/361; 327/9

(57) ABSTRACT

A converting circuit which converts RZ data into intermeidate NRZ data. The intermediate NRZ data is then sampled to detect a phase of the intermediate NRZ data, which corresponds to the phase of the RZ data. In a preferred embodiment, the converting circuit is incorporated in a modified Hogge NRZ phase detector. A toggle flip-flop is placed in front of the Hogge phase detector. Since the toggle flip-flop is triggered by the leading edge of the RZ pulse, it essentially converts the RZ data into intermediate NRZ data. An exclusive-OR gate samples two different output stages of the Hogge NRZ phase detector, with the output stages being separated by an interim stage to provide a clock delay. The output of the exclusive-OR gate is an intermediate NRZ signal that corresponds to the input RZ data stream, which can then be sampled. The exclusive-OR gates inside the Hogge phase detector are used, as in the Hogge phase detector, to produce the up and down signals provided to a charge pump that is part of a PLL. The insertion of the toggle flip-flop allows these same exclusive-OR gates to perform the same function in the present invention.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates to phase detectors for return-to-zero (RZ) data in timing recovery applications.

A number of different circuits exist for detecting the phase of a RZ data signal. Examples are set forth in U.S. Pat. Nos. 5,050,117; 6,324,236; and 5,027,085.

Another type of data is non-return-to-zero (NRZ) data. This data format has recently been popularized in the synchronous optical network (SONET) protocol used in fiber optics. One such NRZ phase detector is commonly referred to as the Hogge phase detector, and is described in U.S. Pat. No. 4,535,459. The Hogge phase detector provides good performance by detecting the phase in a midpoint of a pulse, where there is maximum noise immunity. Unfortunately, the Hogge phase detector is not suitable for RZ data, such as is used in T3, E3 and STS1 systems.

### BRIEF SUMMARY OF THE INVENTION

The present invention provides a converting circuit which converts RZ data into NRZ data. The NRZ data is then sampled to detect the phase of the NRZ data at the midpoint and subsequently recover the timing and data utilizing circuits that are intended for NRZ data.

In a preferred embodiment, the converting circuit is a modified Hogge NRZ phase detector. A toggle flip-flop is placed in front of a modified version of the Hogge phase detector. Since the toggle flip-flop is triggered by the leading edge of the RZ pulse, its output will change state on the leading edge of every RZ pulse. An exclusive-OR gate samples two different output stages of the Hogge NRZ phase detector, with the output stages being separated by an interim stage to provide one full clock period delay. The exclusive-OR, in conjunction with the full clock delay, will produce one full period width pulse for every RZ pulse that feeds the first toggle flip-flop. These pulses are sampled again to generate the output data. The exclusive-OR gates inside the Hogge phase detector are used, as in the Hogge phase detector, to produce the up and down signals provided to a charge pump. The insertion of the toggle flip-flop allows these same exclusive-OR gates to perform the same function in the present invention for RZ data.

In another embodiment of the invention, a dual-rail input signal is processed. The dual-rail signal is first sliced, to provide positive and negative RZ data. Two mirror circuits are provided, each with a Hogge phase detector and toggle flip-flop for generating the phase detect signals. The UP and DOWN signals from the two circuits are exclusive-ORed together.

For a further understanding of the nature and advantages of the present invention, reference should be made to the following description taken in conjunction with the accompanying drawings.

### BRIEF DESCRIPTION OF THE DRAWINGS

FIG. 1 is a block diagram of a prior art Hogge phase detector.

FIG. 2 is a timing diagram of certain signals of the Hogge phase detector of FIG. 1.

FIG. 3 is a timing diagram of the Hogge phase detector of FIG. 1 when presented with NZ data, illustrating the problems.

FIG. 4 is a block diagram of a first embodiment of the present invention.

FIG. 5 is a timing diagram illustrating certain signals of the embodiment of FIG. 4.

FIG. 6 is a block diagram of the embodiment of the present invention of FIG. 4 incorporated into a dual-rail signal system.

### DETAILED DESCRIPTION OF THE INVENTION

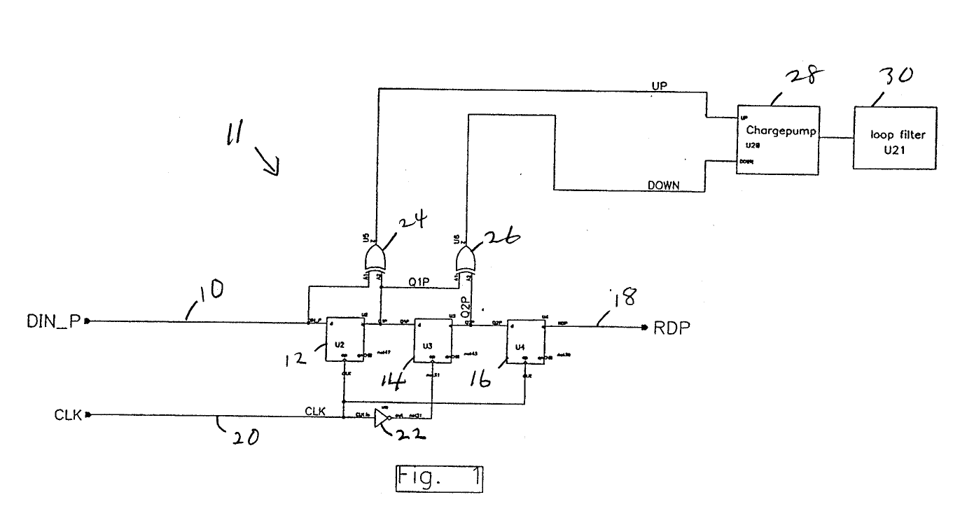

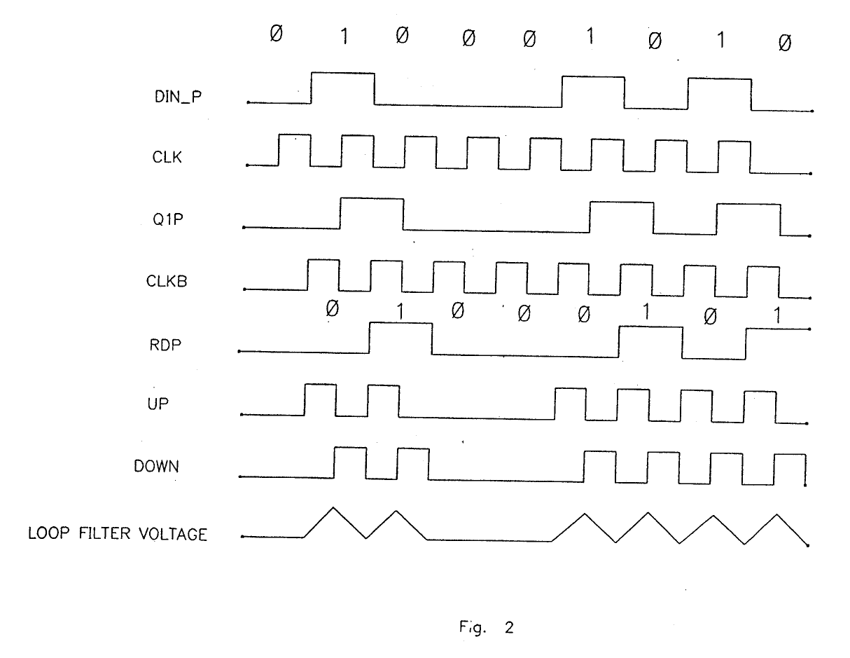

FIG. 1 is a block diagram of a Hogge phase detector, which relies on the NRZ property of data to re-time the input data at the optimal sampling point. A timing diagram with the clock aligned perfectly to the input data transitions is shown in FIG. 2 for an NRZ data stream. The input NRZ signal in FIG. 1 is provided on a line 10 and is labeled DIN_P. This is fed to a series of three flip-flops 12, 14 and 16. An output line 18 provides the output signal RDP.

A clock signal on a line 20 is used to clock the first and third stages, with an inverted clock signal through an inverter 22 being used to clock the intermediate stage 14. The input and output of the first stage 12 are provided to an exclusive-OR gate 24 to provide an UP signal. The input and output of the intermediate stage 14 are provided to a second exclusive-OR gate 26, to provide a DOWN signal. These two signals are provided to a charge pump 28, and then to a loop filter 30.

As can be seen from the block diagram of FIG. 1 and the timing diagram of FIG. 2, the UP pulses are generated during the time interval between data transitions and the next rising edge of the clock. Every UP pulse generates a DOWN pulse with a fixed width of half of the clock period. In an ideal situation the width of the UP and DOWN pulses should be equal to half of the clock period. When the clock leads or lags from this ideal position, the UP pulse becomes smaller or larger than the DOWN pulse, respectively. The UP and DOWN pulses are fed to the charge pump and loop filter which are part of a Phase Lock Loop (PLL). The difference between the pulse width of the UP and DOWN signals is the feedback signal in the PLL.

When the clock is aligned perfectly to the input data transitions, the difference between the pulse widths of UP and DOWN are equal to zero, and the PLL is in a “phase lock” condition. It can be easily seen that the sampling point of the data is optimal since the sampling (rising) edge of the clock is located near the center of the data, thus providing the maximum noise margin.

Referring to FIG. 2, it can be seen that each NRZ pulse provides two UP signals and two DOWN signals, resulting in two UP and DOWN ramps of the loop filter voltage shown at the bottom of FIG. 2.

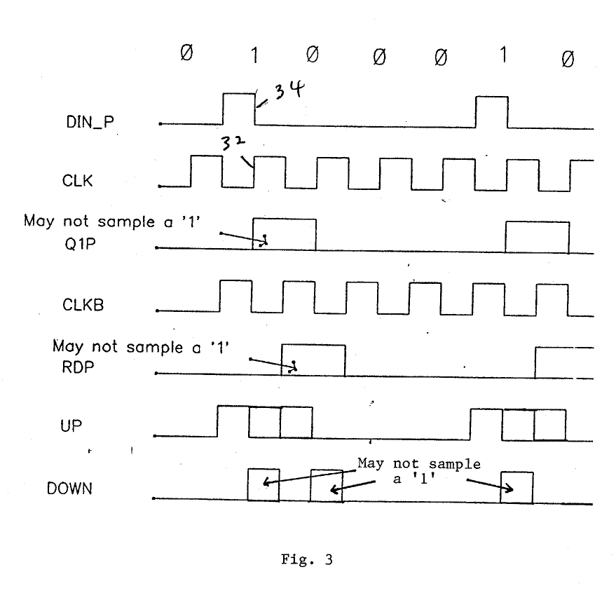

FIG. 3 illustrates what would happen if RZ data is used for the input DIN_P signal shown at the top of FIG. 3. As can be seen, since the clock rising edge 32 is aligned with the falling edge 34 of the RZ data, a misalignment may result in the one pulse not being sampled. Accordingly, this circuit would be very susceptible to noise for RZ data and will not work.

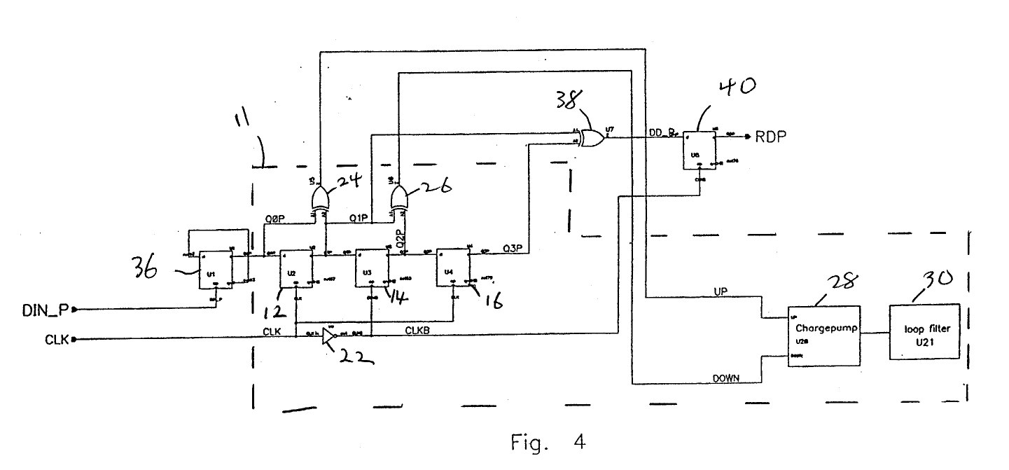

FIG. 4 is a preferred embodiment of the present invention which use a modified Hogge phase detector. The invention includes the Hogge phase detector 11, as illustrated by the dotted lines. In front of the Hogge phase detector is placed a toggle flip-flop 36, with the input data being provided to the clock input and the output being coupled back to the input. The output of flip-flop 36 is provided to the Hogge phase detector 11. An exclusive-OR (XOR) gate 38 is added, with its inputs being the output of flip-flops 12 and 16, the first and third stages of the Hogge phase detector. The output of XOR-gate 38 is now NRZ data which has been created from the RZ data, and is provided to a flip-flop 40 and can be sampled to produce the RDP output signal.

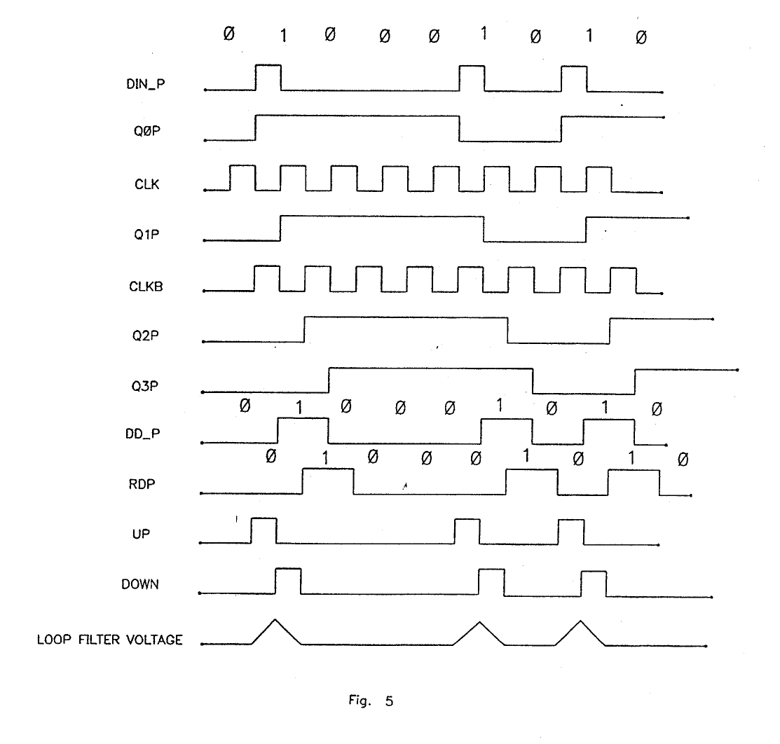

A timing diagram illustrating certain of the signals of FIG. 4 is shown in FIG. 5. As can be seen, the toggle flip-flop causes a signal Q0P to be effectively an intermediate NRZ data that does not change its state again until the next data value of 1. This intermediate NRZ data stream will go through an additional circuit to generate a true NRZ version of the input RZ data. As the leading edge of this long intermediate NRZ pulse progresses through the three stages of the modified Hogge detector, as illustrated by signals Q1P and Q2P and finally Q3P, the inputs and outputs of these stages can be sampled by the exclusive-OR gates 24 and 26 to generate an UP pulse and a DOWN pulse with a fixed width of half a clock period for each transition of the data. When the leading edge of the clock is centered properly by means of a phase locked loop, the width of the UP pulse will be identical to that of the DOWN pulse.

Toggle flip-flop 36 essentially divides the RZ data by two, generating the intermediate NRZ data that is applied to the stages 12, 14 and 16. Flip-flops 12 and 16 are clocked by the true clock signal, while flip-flops 14 and 40 are clocked by the inverted clock after passing through inverter 22.

As can be seen, the exclusive-OR gate 38 using delayed versions of the intermediate NRZ data, produces a new NRZ data that has exactly the same data sequence as the input data stream DIN_P, except that the output is NRZ. As can be seen from the timing diagram of FIG. 5, the CLK rising edge is half a period away from the transitions. Hence, data is re-timed at the optimal sampling point.

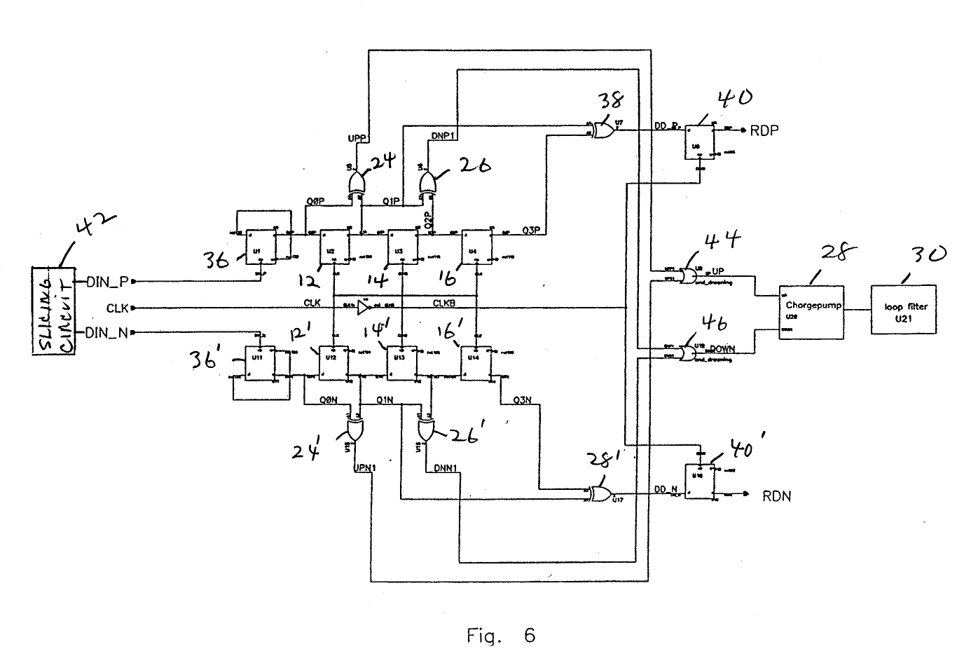

FIG. 6 is a block diagram of the modified Hogge phase detector of FIG. 4 for a dual-rail data stream. A dual-rail data stream is provided to a slicing circuit 42, which slices the positive and negative portions to provide a positive RZ signal DIN_P, and a negative RZ signal, DIN_N. The DIN_P signal is fed to a modified Hogge phase detector as illustrated in FIG. 4, with the same numerals indicating the elements starting with toggle flip-flop 36.

The DIN_N is fed to a mirror Hogge phase detector with a toggle flip-flop 36′ and three stage Hogge detector flip-flops 12′, 14′ and 16′. Also provided are exclusive-OR gates 24′, 26′ and 28′. A D-type flip-flop 40′ provides the re-timed data signal RDN.

Added are OR-gates 44 and 46. OR-gate 44 combines the UP signals from the two detectors and provides them to charge pump 28. OR-gate 46 combines the DOWN signal from the two detectors and provides them to charge pump 28.

As will be understood by those of skill in the art, the present invention may be embodied in other specific forms without departing from the central characteristics thereof. For example, other implementations of an NRZ phase detector could be used after the data is converted from RZ to NRZ. Accordingly, the foregoing description is intended to be illustrative, but not limiting, of the scope of the invention which is set forth in the following claims.

What is claimed is:

1. A phase detector for return-to-zero (RZ) data comprising:
a first converting circuit for converting said RZ data into intermediate non-return-to-zero (NRZ) data; and
a first sampling circuit for sampling said intermediate NRZ data to detect a phase of said intermediate NRZ data.

2. The detector of claim 1 wherein said first converting circuit comprises:
an NRZ phase detector; and
a toggle flip-flop connected between an input line and said NRZ phase detector.

3. The detector of claim 2 wherein said first converting circuit further comprises:
an exclusive-OR gate having inputs connected to two different output stages of said NRZ phase detector, said two different output stages being separated by an interim stage to provide a full clock delay between the two output stages.

4. The detector of claim 1 wherein an input signal is a dual rail signal, and further comprising:
a slicing circuit configured to receive said dual rail signal, for providing positive and negative RZ outputs, a positive output being coupled to said first sampling circuit;
a second converting circuit coupled to said negative output for converting RZ output data into intermediate NRZ data; and
a second sampling circuit for sampling said intermediate NRZ data to detect a phase of said intermediate NRZ data.

5. The detector of claim 4 further comprising:
a first OR-gate coupled to UP signal outputs of said first and second converting circuits; and
a second OR-gate coupled to DOWN signal outputs of said first and second converting circuits.

6. The phase detector of claim 2 wherein said NRZ phase detector is a Hogge phase detector circuit.

7. The phase detector of claim 1 wherein said first converting circuit comprises:
first, second and third flip-flops arranged in series;
a first exclusive OR gate with an UP signal output having inputs coupled to an input of said first flip-flop and an output of said first flip flop; and
a second exclusive OR gate with a DOWN signal output having inputs coupled to the output of said first flip-flop and an output of said second flip-flop.

8. A phase detector for return-to-zero (RZ) data comprising:
a first converting circuit for converting said RZ data into intermediate non-return-to-zero (NRZ) data, said first converting circuit including
an NRZ phase detector, and
a toggle flip-flop connected between an input line and said NRZ phase detector;
a first sampling circuit for sampling said intermediate NRZ data to detect a phase of said intermediate NRZ data; and
an exclusive-OR gate having inputs connected to two different output stages of said NRZ phase detector, said two different output stages being separated by an interim stage to provide a one clock delay between the two output stages.

9. The detector of claim 8 wherein an input signal is a dual rail signal, and further comprising:
a slicing circuit for providing positive and negative RZ outputs, a positive output being coupled to said first sampling circuit;
a second converting circuit coupled to said negative output for converting RZ output data into intermediate NRZ data; and
a second sampling circuit for sampling said intermediate NRZ data to detect a phase of said intermediate NRZ data.

10. The detector of claim 9 further comprising:
a first OR-gate coupled to UP signal outputs of said first and second converting circuits; and
a second OR-gate coupled to DOWN signal outputs of said first and second converting circuits.

11. A phase detector for return-to-zero (RZ) data comprising:
a first converting circuit for converting said RZ data into intermediate non-return-to-zero (NRZ) data, said first converting circuit including
an NRZ phase detector, and
a toggle flip-flop connected between an input line and said NRZ phase detector;
a first sampling circuit for sampling said intermediate NRZ data to detect a phase of said intermediate NRZ data;
an exclusive-OR gate having inputs connected to two different output stages of said NRZ phase detector, said two different output stages being separated by an interim stage to provide a two clock delay between the two output stages;
a slicing circuit configured to receive said dual rail signal, for providing positive and negative RZ outputs, a positive output being coupled to said first sampling circuit;
a second converting circuit coupled to said negative output for converting RZ output data into intermediate NRZ data;
a second sampling circuit for sampling said intermediate NRZ data to detect a phase of said NRZ data;
a first OR-gate coupled to UP signal outputs of said first and second converting circuits; and
a second OR-gate coupled to DOWN signal outputs of said first and second converting circuits.

12. A method for detecting the phase of return-to-zero (RZ) data comprising:
converting said RZ data into intermediate non-return-to-zero (NRZ) data; and
sampling said intermediate NRZ data to detect a phase of said intermediate NRZ data.

13. The method of claim 12 wherein said converting comprises:
toggling an input signal; and
detecting said input as an intermediate NRZ signal.

14. The method of claim 13 wherein said converting further comprises:
exclusive-ORing two different output stages of an NRZ phase detector detecting said intermediate NRZ signal, said two different output stages being separated by an interim stage to provide a two clock delay between the two output stages.

15. The method of claim 12 wherein an input signal is a dual rail signal, and further comprising:
slicing said dual rail signal to provide positive and negative RZ outputs.
